(19) United States
(12) Patent Application Publication
(10) Pub. No.: US 2008/0074496 A1
(43) Pub. Date: Mar. 27, 2008

(54) VIDEO ANALYTICS FOR BANKING BUSINESS PROCESS MONITORING

(75) Inventors: Peter L. Venetianer, McLean, VA (US); Alan J. Lipton, Herndon, VA (US); Zhong Zhang, Herndon, VA (US); Wei Hong Yin, Herndon, VA (US); Li Yu, Herndon, VA (US); Yongtong Hu, Herndon, VA (US); W. A. Scanlon, Fairfax, VA (US); Niels Haering, Reston, VA (US); Paul C. Brewer, Arlington, VA (US); Gary W. Myers, Aldie, VA (US); Andrew J. Chosak, Arlington, VA (US); Robert A. Cutting, Ashburn, VA (US)

Correspondence Address: VENABLE LLP, P.O. BOX 34385, WASHINGTON, DC, 20043-9998, US

(73) Assignee: Object Video, Inc., Reston, VA (US)

(21) Appl. No.: 11/858,496

(22) Filed: Sep. 20, 2007

Related U.S. Application Data
(60) Provisional application No. 60/846,337, filed on Sep. 22, 2006.

(51) Int. Cl. H04N 7/18

(52) U.S. Cl. 348/150; 348/E07.085

(57) ABSTRACT

A system for video monitoring at least one banking business process may comprise a video analytics engine to process video of a bank area obtained by a video camera and to generate video primitives regarding the video; a user interface to define at least one activity of interest regarding the bank area being viewed, wherein each activity of interest identifies a rule and/or a query regarding the bank area being viewed; and an activity inference engine to process the video primitives according to a banking business process, based on each activity of interest from the user interface to determine if any activity of interest occurred in the video.

### CROSS-REFERENCE TO RELATED APPLICATION

This application is a non-provisional application of, and claims priority to, U.S. Provisional Application No. 60/846,337, filed Sep. 22, 2006, entitled “VIDEO ANALYTICS FOR BANKING BUSINESS PROCESS MONITORING,” of common assignee to the present application, and the contents of which is incorporated by reference in its entirety.

### FIELD OF THE INVENTION

The present invention is in the field of video analytics as applied to the monitoring of banking business processes.

### BACKGROUND OF THE INVENTION

Conventional techniques exist for monitoring banking business processes. For example, such conventional techniques involve analysis of sensor data (such as, people counting devices). Other conventional techniques involve analysis of data collected by human observers (i.e., people with clipboards monitoring banking business processes). In more modern implementations of this, video cameras are monitored by remote human observers to extract business intelligence data.

Many banks conventionally employ closed-circuit television (CCTV) cameras on their premises, and the video from the CCTV cameras are observed by one or more humans and/or recorded for later observation by one or more humans. These cameras typically monitor bank lobbies, tellers, automated teller machines (ATMs), vaults, drive through stations, and/or private office spaces. As can be seen, there are many aspects of a bank business that may be monitored via CCTV cameras. However, to monitor or review the video from all of these possible CCTV cameras is a task requiring a significant number of humans and a significant expense. As such, placing CCTV cameras in all desirable locations of a bank and contemporaneously or non-contemporaneously monitoring all the video from these CCTV cameras is very rarely performed.

### SUMMARY OF THE INVENTION

One embodiment of the invention includes a system for video monitoring at least one banking business process comprising: a video analytics engine to process video of a bank area obtained by a video camera and to generate video primitives regarding the video; a user interface to define at least one activity of interest regarding the bank area being viewed, wherein each activity of interest identifies a rule and/or a query regarding the bank area being viewed; and an activity inference engine to process the video primitives according to a banking business process, based on each activity of interest from the user interface to determine if any activity of interest occurred in the video.

One embodiment of the invention includes a method for video monitoring at least one banking business process comprising: obtaining video of a bank area from a video camera; processing the video obtained from the video camera and generating video primitives regarding the video; defining at least one activity of interest regarding the bank area being viewed, wherein each activity of interest identifies a rule and/or a query regarding the bank area being viewed; and processing the video primitives according to a banking business process, based on at least one activity of interest regarding the bank area being viewed to determine if any activity of interest occurred in the video, wherein the at least one activity of interest defines a rule and/or a query selectively identified by a user regarding the bank area being viewed; creating an alert when an activity of interest occurs; combining external data from an external data source with the alert and inferring combined events based on a set of rules and queries, wherein the combining is done in parallel with the video processing; and generating at least one of: a combination alert, and/or a report.

One embodiment of the invention includes a computer-readable medium comprising software for video monitoring at least one banking business process, which when executed by a computer system, cause the computer system to perform operations comprising a method of: processing video of a bank area obtained by a video camera and generating video primitives regarding the video; defining at least one activity of interest regarding the bank area being viewed, wherein each activity of interest identifies a rule and/or a query regarding the bank area being viewed; processing the video primitives according to a banking business process, based on at least one activity of interest regarding the bank area being viewed to determine if any activity of interest occurred in the video, wherein the at least one activity of interest defines a rule and/or a query selectively identified by a user regarding the bank area being viewed; creating an alert when an activity of interest occurs; combining external data from an external data source with the alert and inferring combined events based on a set of rules and queries, wherein the combining is done in parallel with the video processing; and generating at least one of: a combination alert, and/or a report.

One embodiment of the invention includes an apparatus for video monitoring at least one banking business process comprising: a video analytics engine to process video of a bank area obtained by a video camera and to generate video primitives regarding the video; an activity inference engine to process the video primitives from the video analytics engine according to a banking business process, based on at least one activity of interest regarding the bank area being viewed to determine if any activity of interest occurred in the video, wherein each activity of interest defines a rule and/or a query selectively identified by a user regarding the bank area being viewed; and a data combination and inference engine adapted to combine external data from an external data source with an alert to infer combined events based on a set of rules and queries, wherein the combining is done in parallel with the video processing, and to generate at least one of: combination alerts, and/or reports.

### BRIEF DESCRIPTION OF THE DRAWINGS

The foregoing and other features of various embodiments of the invention will be apparent from the following, more particular description of such embodiments of the invention, as illustrated in the accompanying drawings, wherein like reference numbers generally indicate identical, functionally similar, and/or structurally similar elements.

FIG. 1 illustrates an exemplary embodiment of the invention;

FIG. 2 illustrates an exemplary embodiment of the invention when decisions are based not only on the video, but also based on additional external information; and

FIGS. 3A to 3O illustrate images from monitoring exemplary banking business processes using an exemplary embodiment of the invention.

### DEFINITIONS

In describing the invention, the following definitions are applicable throughout (including above).

“Video” may refer to motion pictures represented in analog and/or digital form. Examples of video may include: television; a movie; an image sequence from a video camera or other observer; an image sequence from a live feed; a computer-generated image sequence; an image sequence from a computer graphics engine; an image sequences from a storage device, such as a computer-readable medium, a digital video disk (DVD), or a high-definition disk (HDD); an image sequence from an IEEE 1394-based interface; an image sequence from a video digitizer; or an image sequence from a network.

A “video sequence” may refer to some or all of a video.

A “video camera” may refer to an apparatus for visual recording. Examples of a video camera may include one or more of the following: a video imager and lens apparatus; a video camera; a digital video camera; a color camera; a monochrome camera; a camera; a camcorder; a PC camera; a webcam; an infrared (IR) video camera; a low-light video camera; a thermal video camera; a closed-circuit television (CCTV) camera; a pan, tilt, zoom (PTZ) camera; and a video sensing device. A video camera may be positioned to perform surveillance of an area of interest.

“Video processing” may refer to any manipulation and/or analysis of video, including, for example, compression, editing, surveillance, and/or verification.

A “frame” may refer to a particular image or other discrete unit within a video.

A “computer” may refer to one or more apparatuses and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a personal digital assistant (PDA); a portable telephone; application-specific hardware to emulate a computer and/or software, such as, for example, a digital signal processor (DSP), a field-programmable gate array (FPGA), a chip, chips, or a chip set; an optical computer; a quantum computer; a biological computer; and an apparatus that may accept data, may process data in accordance with one or more stored software programs, may generate results, and typically may include input, output, storage, arithmetic, logic, and control units.

“Software” may refer to prescribed rules to operate a computer. Examples of software may include: software; code segments; instructions; applets; pre-compiled code; compiled code; computer programs; and programmed logic.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; and a memory chip.

A “computer system” may refer to a system having one or more computers, where each computer may include a computer-readable medium embodying software to operate the computer. Examples of a computer system may include: a distributed computer system for processing information via computer systems linked by a network; two or more computer systems connected together via a network for transmitting and/or receiving information between the computer systems; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. Examples of a network may include: an internet, such as the Internet; an intranet; a local area network (LAN); a wide area network (WAN); and a combination of networks, such as an internet and an intranet.

### DETAILED DESCRIPTION OF THE EMBODIMENTS

Exemplary embodiments of the invention are discussed in detail below. While specific exemplary embodiments are discussed, it should be understood that this is done for illustration purposes only. In describing and illustrating the exemplary embodiments, specific terminology is employed for the sake of clarity. However, the invention is not intended to be limited to the specific terminology so selected. A person skilled in the relevant art will recognize that other components and configurations may be used without parting from the spirit and scope of the invention. It is to be understood that each specific element includes all technical equivalents that operate in a similar manner to accomplish a similar purpose. Each reference cited herein is incorporated by reference. The examples and embodiments described herein are non-limiting examples.

The invention may be directed generally to the use of an automated video surveillance system employing video analytics for monitoring banking business processes. Video analytics may refer to the application of computer vision techniques to extract useful data or information from video streams or video sequences. Specifically, the invention may be applied to the banking business processes involving physical security, public safety, loss prevention, and business intelligence data gathering, including employee effectiveness.

Examples of applying embodiments of the invention to banking business processes involving physical security may include, for example, detection of: an intrusion within a banking facility; a vandalism act within or around a banking facility; unauthorized access to a secure area (known as “tailgating”); an illegal number of people in secure area, e.g. at least two people should be present when opening a safe, but there is only one; suspicious behavior around cars in a parking lot; suspicious behavior around an ATM; installation of a skimmer device on an ATM; teller withdrawal without a customer present; only one employee present for transactions requiring at least two employees; a customer reaching over the teller station and grabbing money; a person holding a gun; and/or detection of camera tampering.

Examples of applying embodiments of the invention to banking business processes involving public safety may include, for example, detection of: people slipping and falling on bank property; people running in a bank or a parking lot; an assault or abduction in a parking lot; a car speeding in a parking lot; a car driving in a wrong direction at the drive through teller window; an obstruction of a fire exit; an illegally parked vehicle; an abandoned package; a vehicle proceeding in the wrong direction in a drive-through teller window; and/or crowding in a bank area or outside of the bank.

Examples of applying embodiments of the invention to banking business processes involving business intelligence data gathering may include, for example: queue length monitoring; monitoring of cleanliness; monitoring of an unattended delivery; and/or measuring customer service process through people tracking by monitoring employee-customer interactions.

Intelligent video may be applied to these banking processes in at least two operating modes: standalone and integrated.

In the standalone mode, operation of the video analysis engine may be based solely on what is detected in the video, without any additional information. Standalone applications may include detecting vandalism, camera tampering, change in the appearance of an ATM, person loitering in an ATM vestibule, queue length monitoring, etc.

In the integrated mode, the intelligent surveillance system may combine what is detected in the video with additional external information. The external information may come, for example, from a card swipe reader, which would allow comparison of a number of card swipes with a number of people to detect tailgating; from an ATM, to know when a transaction starts and ends, so that a person standing for a long time at an ATM without initiating a transaction may be flagged as suspicious; or from a teller, to know when a transaction is taking place, so that the presence of a customer may be verified during a withdrawal.

The exemplary automated video surveillance system of the invention may employ low-level video analytics algorithms to process the video feeds from bank surveillance to extract all of the objects of interest, while ignoring any irrelevant background motion. These objects of interest may be described via a set of “video primitives,” which may be a text description of all of the objects and observable features within a video. These video primitives also may include, for example, descriptions of the objects, their locations, velocities, shape, colors, location of body parts, etc.

The video primitives may be analyzed in a real-time mode via an activity inference engine to determine if an activity of interest has occurred, and/or stored in a database for such further analysis. These activities may be presented as “alerts” to a user or gathered together to generate a report for a user.

In addition to, or instead of, this real-time mode, the system may also operate in an off-line mode, e.g., forensic mode, wherein queries may be applied to archived video primitives after the fact. In the off-line mode, the user may look for activities by mining the video primitives, instead of the entire video analytics again.

The exemplary automated video surveillance system of the invention may be implemented as disclosed in the following, for example, which are incorporated herein by reference: U.S. Patent Publication No. 2005-0146605-A1, “Video Surveillance System Employing Video Primitives”; U.S. Patent Publication No. 2005-0162515 A1, “Video Surveillance System”; U.S. Patent Publication No. 2005-0169367-A1, “Video Surveillance System Employing Video Primitives”; U.S. patent application Ser. No. 11/167,218, “Video Surveillance System Employing Video Primitives,” Attorney Docket No. 37112-219035; and U.S. patent application Ser. No. 11/300,581, “Video Surveillance System Employing Video Primitives,” Attorney Docket No. 37112-225921.

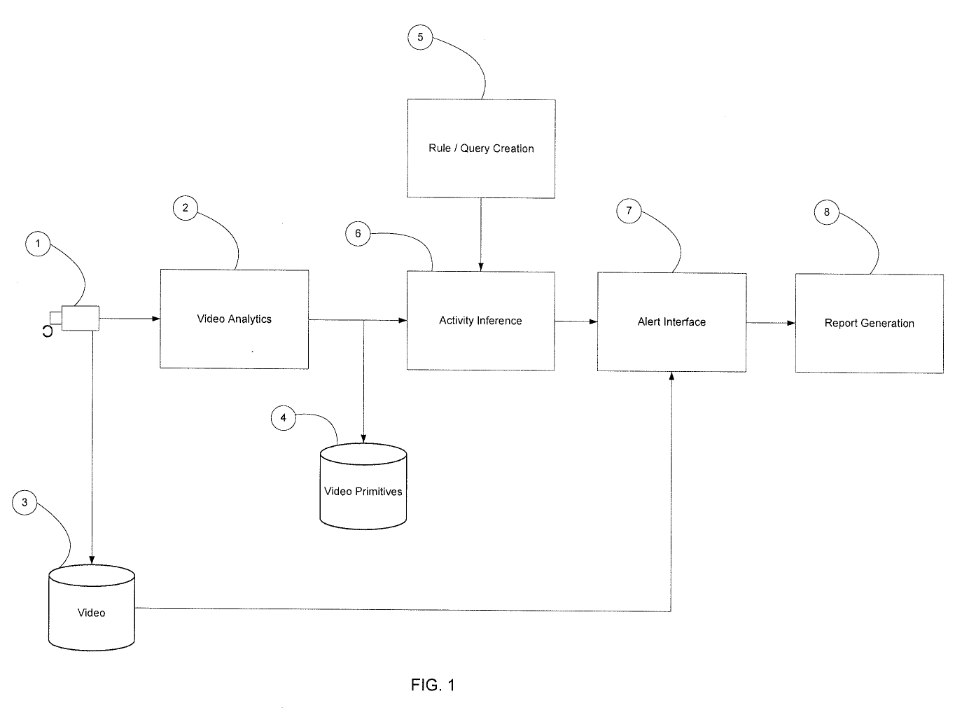

FIG. 1 illustrates an exemplary embodiment of the invention. FIG. 1 shows a description of the basic functional blocks of the exemplary automated video surveillance system of the invention. A video camera 1 may be positioned to view an area of a bank. Optionally, the video from the video camera 1 is stored in a video database storage 3. In block 2, the video from the video camera 1 may be processed by a video analytics engine to produce video primitives. These video primitives may be stored in a database storage 4. In block 5, a user may define at least one activity of interest via a user interface for defining rules and/or queries. In block 6, an activity inference engine may process the video primitives from block 2 based on the activities of interest from block 5 to determine if any of these activities occurred in the video. In block 7, an alert interface engine generates an alert if an activity of interest is determined to have occurred in block 6. The alert may include video primitive data and (optionally) associated video imagery from the video database storage 3. The alert may trigger a response. Optionally, in block 8, a report generation engine may generate a report for the alerts from block 7.

In terms of the architecture of the exemplary automated video surveillance system, a number of different embodiments may be used. For example, the various embodiments described in the following, which is incorporated herein by reference, may be used with the invention: U.S. patent application Ser. No. 11/165,182, “Detection of Change in Posture in Video,” Attorney Docket No. 37112-219109. In one embodiment, the video analytics engine of block 2 and the activity inference engine of block 6 may be co-resident on a single device (e.g., a computer or a chip, chips, or a chip set). The single device may be resident within the video camera 1, an encoder, a router, a digital video recorder (DVR), a network video encoder (NVR) or some other network video device. In another embodiment, the video analytics engine of block 2 and the activity inference engine of block 6 may be on separate devices. For example, the first device of the video analytics engine of block 2 may be a computer or a chip, chips, or a chip set and may be resident within the video camera 1, an encoder, a router, a digital video recorder (DVR), a network video encoder (NVR) or some other network video device. Meanwhile, the second device of the activity inference engine of block 6 may be a computer or a chip, chips, or a chip set and may be resident within an encoder, a router, a digital video recorder (DVR), a network video encoder (NVR) or some other network video device connected to the first device via a network. In this case, only the video primitives may need to be sent across the network for the proper operation of the system.

In block 2, the video analytics engine may process the video from the video camera 1 in real-time and produces video primitives. Examples of the type of algorithms that may be employed by the video analytics engine are disclosed in the following, for example, which are incorporated herein by reference: U.S. Pat. No. 6,625,310, “Video Segmentation Using Statistical Pixel Modeling”; U.S. Pat. No. 6,696,945, “Video Tripwire”; U.S. Patent Publication No. 2005-0146605 A1, “Video Surveillance System Employing Video Primitives”; U.S. Pat. No. 6,987,883, “Video Scene Background Maintenance Using Statistical Pixel Modeling”; U.S. Patent Publication No. 2005-0168574-A1, “Video-Based Passback Event Detection”; U.S. Patent Publication No. 2004-0151374-A1 “Video Segmentation Using Statistical Pixel Modeling”; U.S. Pat. No. 6,970,083, “Video Tripwire”; U.S. Patent Publication No. 2006-0066722-A1, “View Handling in Video Surveillance Systems”; U.S. Patent Publication No. 2006-0066719-A1, “Method of Finding Paths in Video”; U.S. Patent Publication No. 2006-0072010-A1 “Target Property Maps for Surveillance Systems”; U.S. Patent Publication No. 2005-0162515-A1, “Video Surveillance System”; U.S. Patent Publication No. 2005-0169367-A1, “Video Surveillance System Employing Video Primitives”; U.S. patent application Ser. No. 11/113,275, “Line Textured Target Detection and Tracking with Applications to ‘Basket-Run’ Detection,” Attorney Docket No. 37112-217049; U.S. patent application Ser. No. 11/132,213, “Periodic Motion Detection with Applications to Multi-Grabbing,” Attorney Docket No. 37112-217806; U.S. patent application Ser. No. 11/139,600, “Multi-State Target Tracking,” Attorney Docket No. 37112-218196; U.S. patent application Ser. No. 11/139,986, “Human Detection and Tracking for Security Applications,” Attorney Docket No. 37112-218471; U.S. patent application Ser. No. 11/167,218, “Video Surveillance System Employing Video Primitives,” Attorney Docket No. 37112-219035; U.S. patent application Ser. No. 11/165,182, “Detection of Change in Posture in Video,” Attorney Docket No. 37112-219109; U.S. patent application Ser. No. 11/165,435, “Target Detection and Tracking from Overhead Video Streams,” Attorney Docket No. 37112-219452; U.S. patent application Ser. No. 11/221,923, “Video Surveillance Using Spatial-Temporal Motion Analysis,” Attorney Docket No. 37112-222928; U.S. patent application Ser. No. 11/288,200, “Detection of Stationary Objects in Video,” Attorney Docket No. 37112-224862; and U.S. patent application Ser. No. 11/300,581, “Video Surveillance System Employing Video Primitives,” Attorney Docket No. 37112-225921.

For example, the video analytics engine of block 2 may determine the following information: detecting objects of interest; classifying objects in classes such as human, vehicle, or other; tracking of objects through a scene; determining if an object is inserted into a scene or removed from a scene; detecting an object moving against a flow of traffic; determining the “normal” size, shape, or speed of an object in an area; determining the “normal” path of an object through an area; determining if a customer reaches over into the teller area; determining if a person has slipped and fallen; and/or determining the density of a crowd in a scene.

The video analytics engine of block 2 may generate video primitives. The video primitives may be categorized in the following categories: time video primitives; blob video primitives; target video primitives; environmental video primitives; flow-control video primitives; and/or special purpose video primitives for banking business processes.

Each type of video primitive may contain generic primitive data. Generic primitive data may be generic identification information. Table 1 lists some exemplary generic primitive data that may include the following exemplary generic identification information.

TABLE 1

| Generic | |
|---|---|
| Primitive Data | Exemplary Generic Identification Information |
| Primitive identifier | A globally unique identifier (GUID) for each |
| | primitive. |
| Sensor identifier | A GUID for the video camera that |
| | generated the video. |
| Video time | A timestamp of video frame to which primitive |
| | corresponds. |
| View identifier | A GUID for which view the system is in, |
| | which may be useful when a video camera is |
| | operating in multi-view mode (such as |
| | a PTZ camera on a guard tour). |

Time video primitives may be generated periodically to provide a heartbeat to the system, even if nothing is happening in the video. Hence, no other video primitives are sent. The time video primitives may contain only generic primitive data.

Blob video primitives may be generated when a blob is detected. A blob may refer to a single frame instance of a spatially continuous moving target. Blob video primitives may contain generic primitive data and blob primitive data. The blob primitive data may be spatial descriptors. Table 2 lists some exemplary blob primitive data that may include the following exemplary information.

TABLE 2

| Blob Primitive Data | Exemplary Information |
|---|---|
| Area | Number of pixels comprising the blob. |
| Perimeter | Number of pixels comprising the boundary of the blob. |
| Bounding box | (x, y) coordinates of top-left and bottom-right of blob bounding |
| | box. |
| Centroid | (x, y) coordinates of blob centroid. |
| Foot location | (x, y) coordinates of the location of the bottom of the object (e.g., |
| | the feet in the case of a human, or the wheels in the case of a |
| | vehicle or a shopping cart. |
| Number of | For a blob containing humans, the number of individual human |
| objects/humans | objects detected. |
| Human head | If human heads are detected, the (x, y) location of the heads and |
| locations | the radius of the heads. |
| Color properties | 10 bin (7 colors, 3 shades) HSV-based histogram of blob colors |
| | and shades. |
| Shape | Bitmask of object shape. |
| Skin-tone | Bitmask of pixels with skin-tone coloration. |
| Blob imagery | Image of the blob. |

Target video primitives may describe a snapshot of a moving target and may contain generic primitive data and target primitive data. A target may refer to a complete description of a target over time (e.g., a sequence of blobs). Table 3 lists some exemplary target primitive data that may include the following exemplary information.

TABLE 3

| Target Primitive Data | Exemplary Information |
|---|---|
| Target identifier | A GUID for each target. |
| Target age | Time since target was first seen. |
| Instantaneous velocity | Velocity of target at this time. |
| Classification | Histogram of classifications: human, vehicle, |
| | etc. with confidence values |
| Stationary properties | Insertion, removal, or moving; or active or |
| | passive stationary target. |
| Salience properties | Is target moving in a salient (purposeful) way? |
| Target inheritance | Describing targets splitting and merging. |
| properties | |
| Target occlusion status | Occluded, appearing, disappearing, fully visible. |
| Temporal position | Is video primitive the first, the last, or |
| | between other targets. |
| Blob primitive data | Frame - specific blob primitive data for the target. |

Environmental video primitives may describe an environmental change and may contain generic primitive data and environmental primitive data. Exemplary environmental primitive data may include, for example, a type of environmental change, e.g., lights on/off, camera moved; and/or a start and end time of change.

Flow-control video primitives may describe the detected motion for the flow within the video and may contain generic primitive data and flow-control primitive data. For flow-control video primitives, the scene may be decomposed into a series of grid elements, and the flow may be computed in each one. Exemplary flow-control primitive data may include, for example, a location of the grid element, e.g., a (x,y) coordinate of grid element; and/or a motion vector of the grid element, e.g., a (x,y) motion vector at that element.

Special purpose video primitives may be generated for special applications or for debugging. Examples of special purpose video primitives may include: a “basket run” video primitive; a high-value item stealing video primitive; a tide filter video primitive; an omni-directional video primitive; a reaching primitive; and/or a motion histogram video primitive.

A “basket run” video primitive may indicate the start and end point of detected line segments. This video primitive may be used, for example, for detection of a retail “basket run,” where a basket full of merchandise goes through the front door of a store without payment.

A high-value item stealing video primitive may indicate the position and direction, e.g., up and/or down of motion blocks. This may be used, for example, for detection of someone “cleaning out” a retail shelf. This video primitive may be used to count the number of times a customer has reached into a shelf.

A reaching primitive may indicate a person reaching into a restricted area from a wrong direction.

A tide filter video primitive may indicate the end position of the tide area for each row. This video primitive may be used for automatic detection of tidal areas in maritime environments.

An omni-directional video primitive may indicate warped image dimensions. This video primitive may be used for determining location and orientation of objects in an omni-directional image view.

A motion histogram video primitive may indicate a motion histogram for the whole image. This video primitive may be used for various anomaly detection rules.

In block 6, the activity inference engine may be considered to be a query engine that analyzes the video primitives based on one or more user-defined queries or rules from block 5 and determines activities of interest. This query language is described in the following, for example, which is incorporated herein by reference: U.S. Patent Publication No. 2005-0162515 A1, “Video Surveillance System.” The queries or rules include rule elements and combinators.

Rule elements detect properties and behaviors of targets. Table 4 lists some exemplary rule elements, along with examples thereof.

TABLE 4

| Rule | Example |
|---|---|
| Tripwire crossing | Did target cross tripwire in prescribed direction? |
| Area/region of interest | Did target enter, exit, appear, disappear, go |
| | inside, loiter in prescribed area? |
| Classification type | Is target a human, a vehicle, etc.? |
| Stationary mode | Is it an insertion, removal, or moving? |
| | How long has the target been in this state? |
| Size | Bigger than, smaller than, size changed |
| | more/less than |
| Speed | Faster than, slower than. |
| Color | Does target contain/exclude the prescribed |
| | color(s)? |
| Salience | Is target moving in a salient fashion? |
| Time | Is current time in prescribed time window? Is |
| | the time a recurring or repetitive pattern? |
| Change in speed | Did the speed of the target suddenly change in a |
| | prescribed way: speed up, slow down or either? |
| Change in direction | Did the direction of motion of the target |
| | suddenly change? |
| Environmental | Did a prescribed type of environmental change? |
| | Lights on/off? Camera motion occur? |
| Passback for an area of interest | Did something move in an illegal direction? |
| (AOI) | |
| Slip and fall | Did a target fall or get up? |
| Basket run in an AOI | Did a shopping cart move in an illegal direction? |
| Multiple grab in an AOI | Did a person reach a prescribed number of times |
| | into an area? |
| Single directional grab in an AOI or | Did a person reach into an area or over a |
| across tripwire | boundary? |
| Target counter in an AOI | Count number of targets in AOI and report if |
| | e.g. more than threshold/less than |
| | threshold/equal to threshold/changes over |
| | threshold/change in number, etc. |
| Dwell in an AOI | Calculate and report the length of time targets |
| | spend in AOI. May include minimum and/or |
| | maximum time threshold (report only of dwell if |
| | longer and/or shorter than minimum/maximum |
| | threshold. May include number of targets |
| | threshold, e.g. report only if at least prescribed |
| | number of people dwell concurrently for at least |
| | prescribed time period in AOI. |
| General anomaly | Is something unusual, very different from the |
| | normal behavior? Unusual size, speed, path, |
| | and/or direction? |
| Unusual property | Is a particular target property unusual? Too big, |
| | too small, too fast, too slow, wrong color? |

Combinators may combine rules and/or other combinators as parameters (known as sub-events). An event occurs if the combination succeeds. Table 5 lists exemplary combinators, along with examples thereof.

TABLE 5

| Combinator | Definition/Example(s) |
|---|---|
| And: | All sub-events succeed at the same time. |
| Or: | At least one of the sub-events succeeds. |
| AndCombinator: | All sub-events succeeded, fulfilling user-defined spatial, temporal |
| | and/or target relationships between them. A vehicle parked and |
| | within 30 sec (temporal relationship) a person appeared near it |
| | (spatial relationship). A person crossed a tripwire and more than |
| | 30 sec later (temporal relationship) the same person (target |
| | relationship) crossed another tripwire. |
| Match: | Two sub-events succeed within a certain amount of time in a given |
| | order (e.g., a card is swiped and within 20 sec a person enters the |
| | door. The result of the match combinator may be that: the two |
| | sub-events succeeded (e.g., normal behavior); the first sub-event |
| | happened without the second sub-event; the first sub-event |
| | happened twice without the second; or the second sub-event |
| | happened without the first (e.g., someone entered without a card swipe). |

An exemplary automated video surveillance system may also track individuals across cameras. This may allow for the detection of unusual or suspicious behavior around an entire bank as targets are tracked from one camera to another. This tracking of targets using multiple cameras is described in the following, for example, which is incorporated herein by reference: U.S. patent application Ser. No. 11/098,579, “Wide-Area Site-Based Video Surveillance System,” Attorney Docket No. 37112-215813.

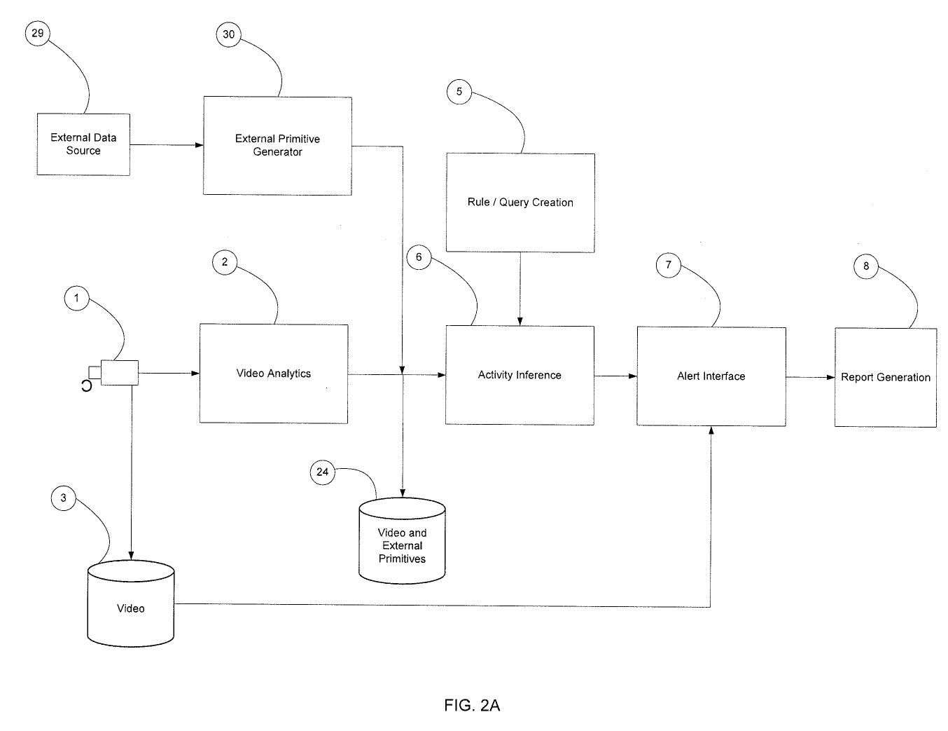

An exemplary embodiment of the integrated mode combining video analytics and additional data may convert the external information into external primitives, which then can be fed to activity inferencing together with the video primitives, as illustrated in FIG. 2A. The video may be analyzed and turned into video primitives in block 2, while the external information (e.g. card swipe or transaction information) from the external data source 29 is converted into external primitives in block 30. These external primitives may be stored along with the video primitives (block 24), and are also fed to the activity inferencing (block 6) which may generate alerts for the active rules and queries (block 5).

In another exemplary embodiment of the integrated mode, the video analytics and the additional data may be combined as illustrated in FIG. 2B. The video analytics system 2 may process the video 1, store video 3 and video primitives 4, perform activity inferencing 6, and create alerts 7 based on rules and queries 35. In parallel to the video processing, the external data source 29 may generate external data, which may be combined with the alerts 7 to infer combined events 32 based on rules and queries 34, to generate combination alerts 36 and reports 8. This embodiment is particularly useful when there is concern about exporting the external data, e.g. due to privacy concerns.

Based on the exemplary embodiment of the invention, one of ordinary skill in the art would understand how particular banking business processes may be monitored by using the user-defined rule from block 5 in conjunction with the video primitives generated from block 2. The following is a list of exemplary banking business processes that may be monitored and exemplary rules that may be generated to monitor these banking business processes.

The following exemplary banking business processes involving physical security may be monitored by the following exemplary rules.

Intrusion detection within a banking facility may be detected when a person crosses perimeter, e.g., a tripwire, after normal hours. Exemplary rules are further discussed in the following, which are incorporated herein by reference U.S. Pat. No. 6,696,945, “Video Tripwire”; and U.S. Pat. No. 6,970,083, “Video Tripwire”.

Vandalism may be detected within or around a banking facility when an object, e.g., a poster or graffiti, is “inserted” onto a wall area. Unauthorized access to a secure area, e.g. “tailgating,” may be detected when two people enter a doorway area with only one access control event. Suspicious behavior around cars in a parking lot may be detected, for example, when a person visits multiple cars in a parking lot and lingers around each for a period of time. Suspicious behavior in an ATM vestibule may be detected, such as loitering or sleeping.

Suspicious behavior around an ATM may be detected, e.g. a person standing in front of the machine without a transaction, which may be an indication of installing a skimmer; or a person approaching another person who is conducting a transaction, which may indicate the person is trying to attack the person using the ATM. These applications may require the integrated mode, combining video analytics with additional non-video information (the presence or absence of a transaction).

Additional exemplary banking business processes involving physical security may be monitored, such as, for example, detection of a change in the appearance of an ATM, potentially indicating the installation of a skimmer; detection when a camera is tampered with, e.g. when the camera is moved, covered, or blinded; and/or detection of employees violating internal processes, such as a single employee carrying out a transaction requiring two people, for example, at a teller station, or at a safe.

Detection of suspicious transactions may also be monitored, such as a teller withdrawal without the presence of a customer. This application requires the integrated mode, combining video analytics with additional non-video information, i.e., the presence or absence of a transaction.

Embodiments of the invention may monitor banking business processes involving public safety. For example, embodiments of the invention may detect people slipping and falling on bank property. Exemplary rules related to detection of a slip and fall event are discussed in the following, which is incorporated herein by reference: U.S. patent application Ser. No. 11/165,182, “Detection of Change in Posture in Video,” Attorney Docket No. 37112-219109.

Embodiments of the invention may detect people running in a bank or a parking lot, for example, by detecting a person moving at speed faster than normal in the bank or parking lot area; and may also detect a car speeding in a parking lot by detecting a car moving faster than normal in a parking lot area. Exemplary rules related to detection of people or objects moving quickly are further discussed in the following, which is incorporated herein by reference: U.S. Patent Application Publication No. 2006-0072010-A1 “Target Property Maps for Surveillance Systems”.

Embodiments of the invention may detect an assault or abduction in a bank parking lot or at an ATM, for example, by detecting two or more people coming together from different directions and one running away afterward; or one person running towards another one and then both leaving in a different direction.

Embodiments of the invention may detect an obstruction of a fire exit, for example, by detecting an object inserted in fire door area.

Embodiments of the invention may detect crowding in a bank area or outside of the bank, for example, by detecting a high density crowd that appears for longer than “x” minutes in a bank area.

Embodiments of the invention may detect a vehicle driving in the wrong direction at the drive-through teller.

Embodiments of the invention may monitor banking business processes involving intelligence data gathering. For example, embodiments of the invention may track people through bank areas to determine, for example, how many people go through a bank area, for example, by counting alerts each time person enters or exits the area. Embodiments of the invention may track where people dwell on bank premises, for example, by counting how long people loiter in a particular area.

Embodiments of the invention may monitor queue length, for example, by counting how many people are in line. Exemplary rules for detecting counting people are further discussed in the following, which is incorporated herein by reference: U.S. patent application Ser. No. 11/165,435, “Target Detection and Tracking from Overhead Video Streams,” Attorney Docket No. 37112-219452.

Embodiments of the invention may monitor bank cleanliness, for example, by monitoring a bank area for spills or fallen merchandise or displays. Embodiments of the invention may monitor an unattended delivery, for example, when delivery people are not there at the right time, or move to unauthorized areas of the bank.

Embodiments of the invention may measure customer service processes through people tracking by monitoring employee-customer interactions, for example, by comparing the time a customer service employee spends with a customer.

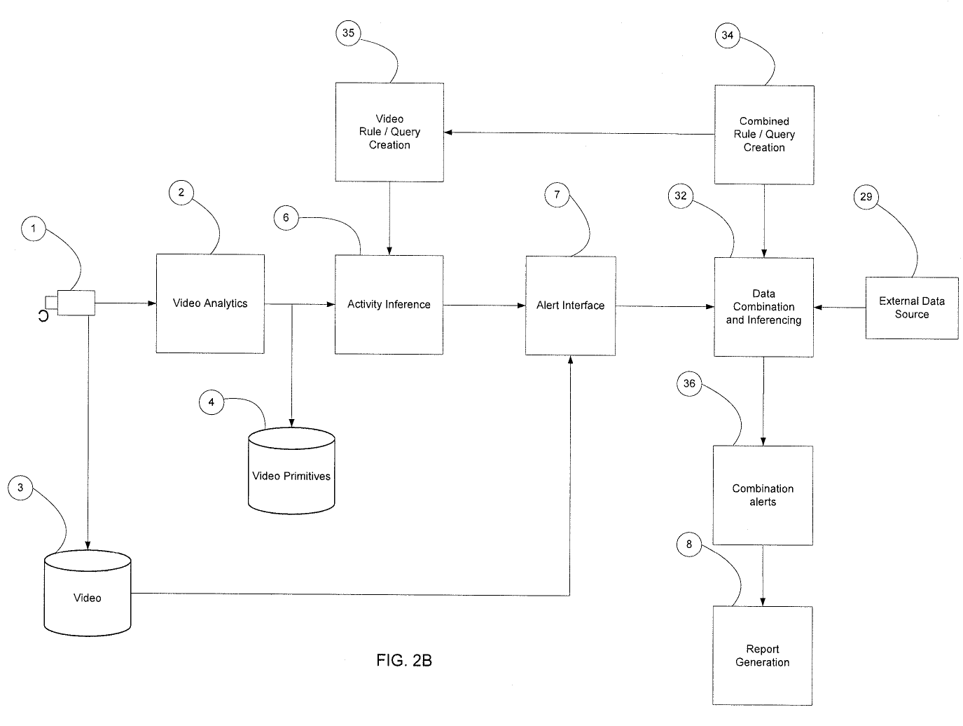

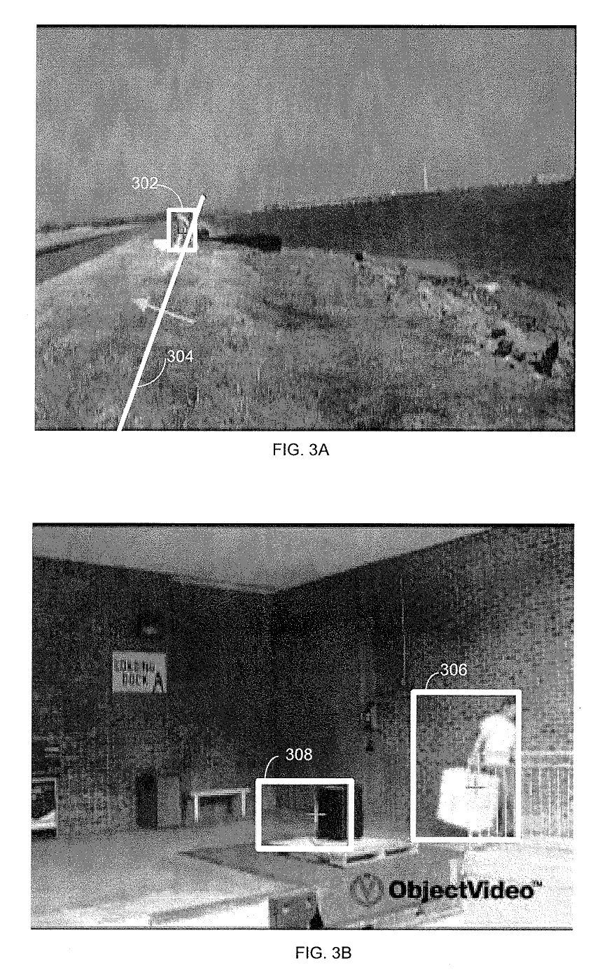

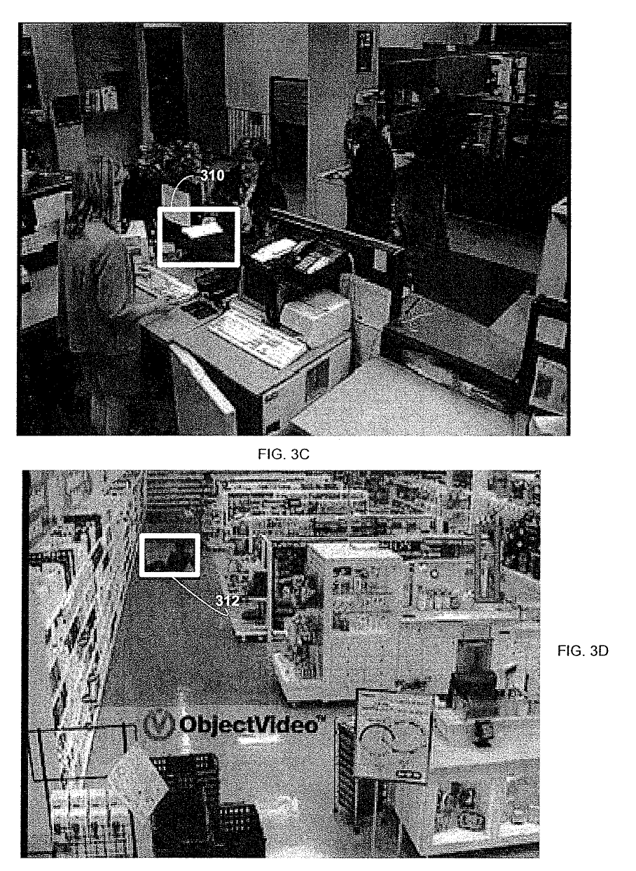

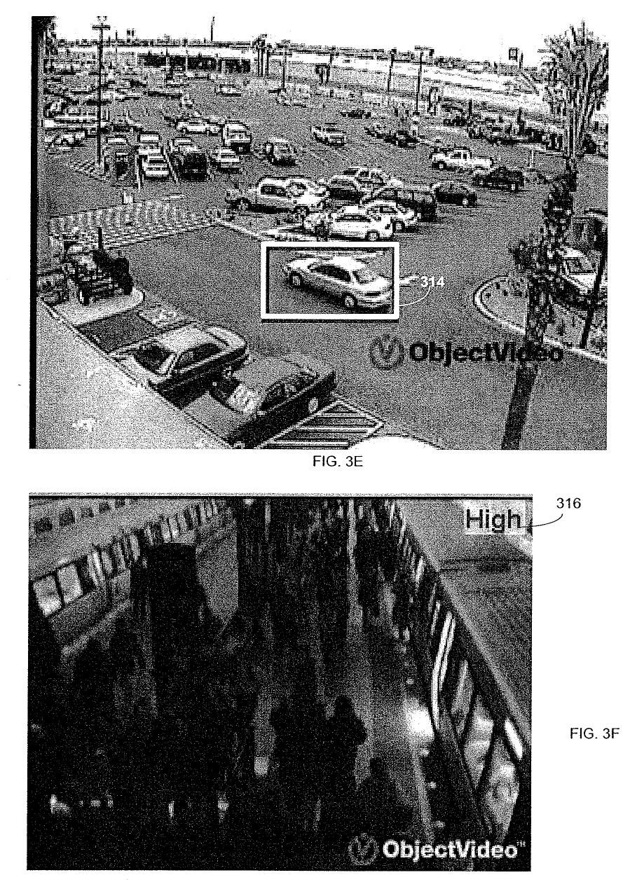

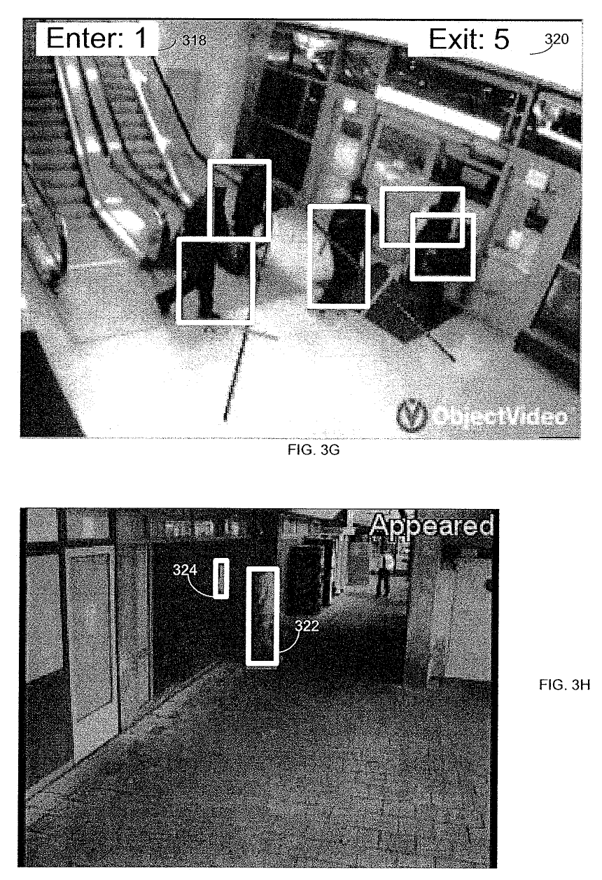

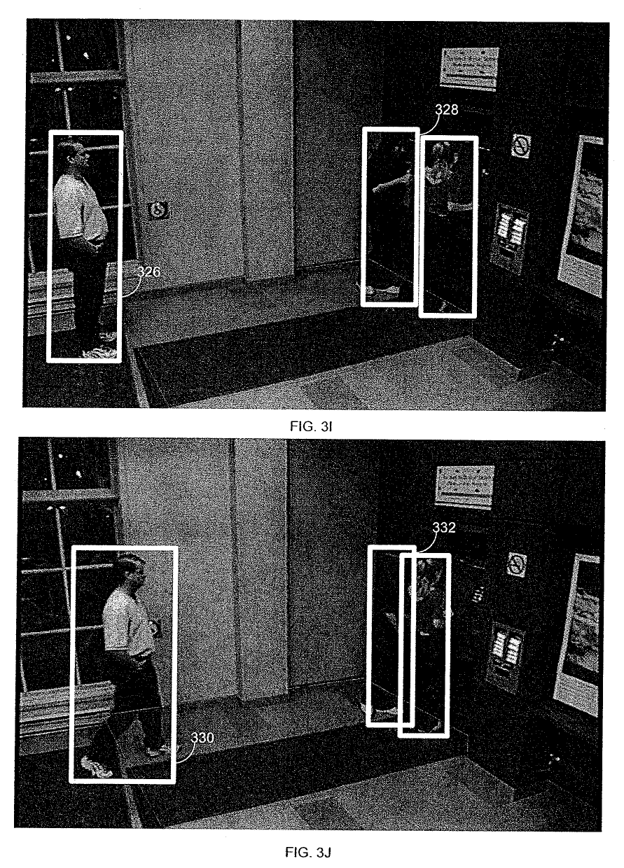

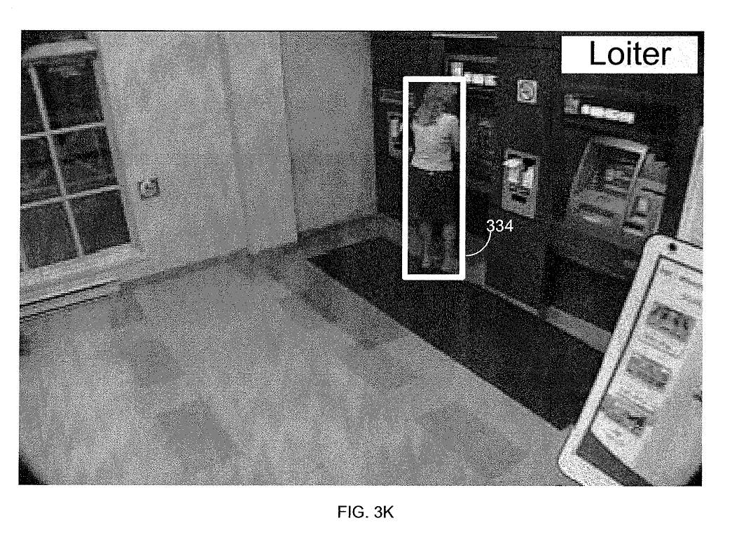

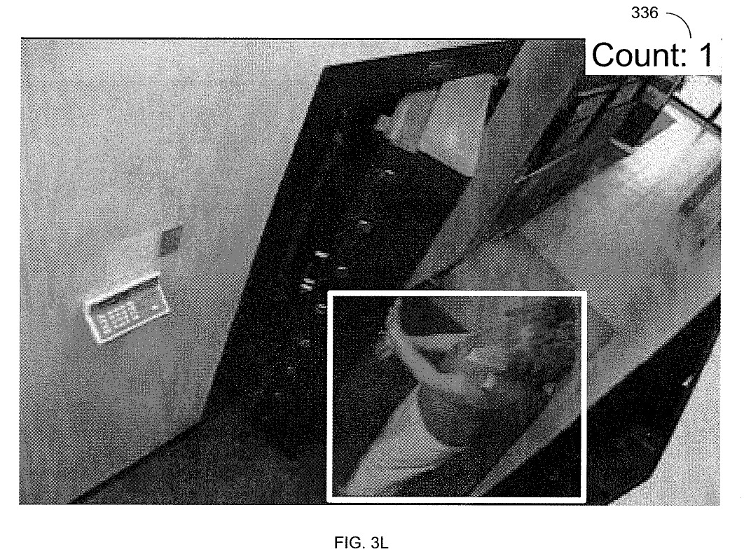

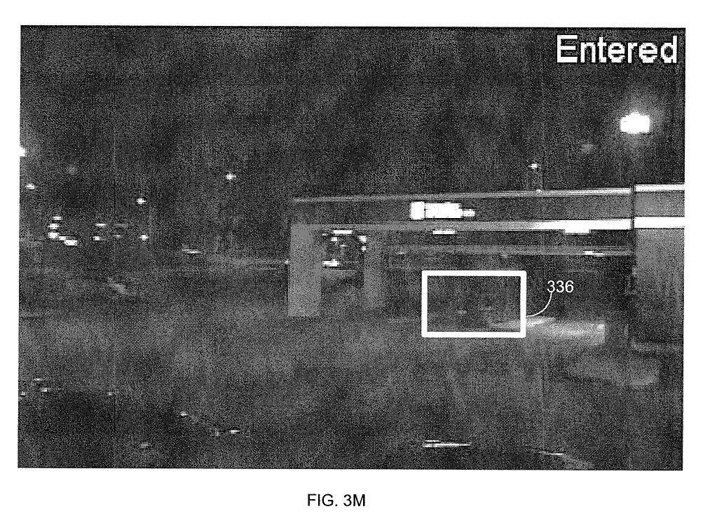

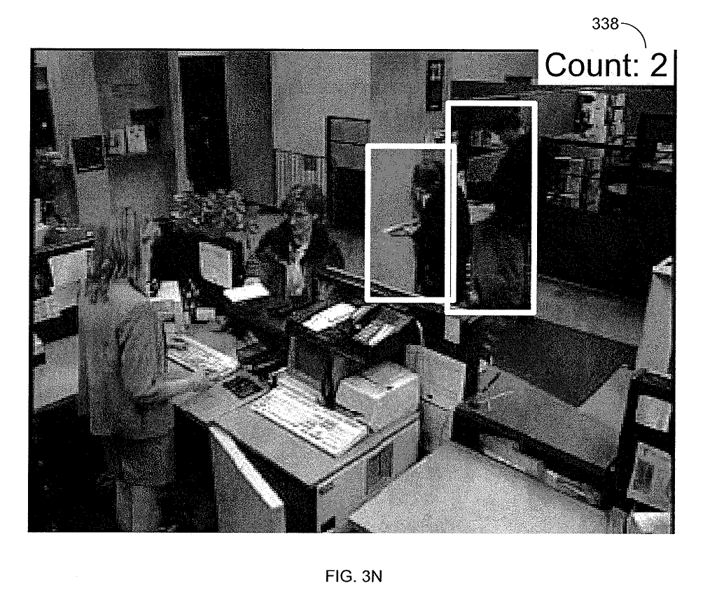

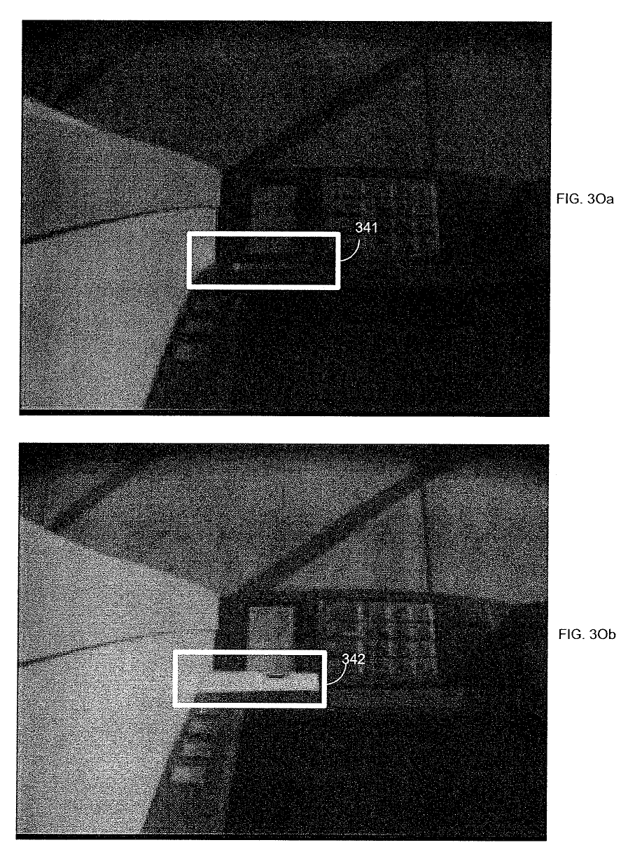

FIGS. 3A to 3N illustrate images from monitoring exemplary banking business processes using exemplary embodiments of the invention. The images were obtained from exemplary automated video surveillance systems employing exemplary rules. Although some of the images do not portray a specific bank setting, one of ordinary skill in the art can appreciate that analogous detection may take place on or around bank premises.

FIG. 3A depicts a physical security example. Here, the system is detecting an intruder 302 who enters and crosses a virtual perimeter using, for example, a tripwire 304.

FIG. 3B depicts a theft of goods 306 from a loading dock 308.

FIG. 3C depicts a person being detected while reaching over 310 into the teller area.

FIG. 3D depicts the system detecting a slip and fall 312.

FIG. 3E depicts the system detecting a car 314 moving abnormally fast in a parking lot.

FIG. 3F depicts the system detecting a high density crowd of people 316.

FIG. 3G depicts system counting the people coming into 318, or out of 320, a building. Here, two directional tripwires are used to detect entry and exit events, and the system counts the number of events from each of these tripwires.

FIG. 3H depicts the system detecting vandalism. Here, a person 322 is putting up a poster 324 in an unauthorized area.

FIGS. 3I and 3J depict the system detecting when a person approaches others during an ATM transaction: in FIG. 3I the person 326 is standing at a distance during the transaction of 328, while in FIG. 3J the person 330 moves closer to 332, causing an alert.

FIG. 3K depicts the system detecting a person 334 standing (loitering) in front of the ATM machine for an extended period of time, without starting a transaction.

FIG. 3L depicts the system counting the number of people present when opening a safe, and alerting when the number of people observed doesn't match that required by the internal processes. In the Figure there is only one person 336 instead of the minimally required two people.

FIG. 3M depicts the system detecting a car 338 parked illegally at a drive through ATM.

FIG. 3N depicts the system counting the length of the line 340 at a teller.

FIG. 3Oa depicts an ATM with no skimmer device in area 341, and FIG. 3Ob depicts the system detecting a card skimmer device 342 placed on the ATM shown in FIG. 3Oa.

In block 8, the report generation engine accumulates events into a report that may provide an overview of banking business processes. For example, for the banking business process of intelligence data gathering, an example report may include people counting and queue length statistics. For people counting, if it is desired to count the number of people who enter or exit a bank, the report generation engine may be used to agglomerate individual entry and exit events (detected via a tripwire(s), for example) and provide a time-based histogram of consumer behavior. For queue length monitoring the automated video surveillance system may determine typical waiting times.

The invention has been described in detail with respect to preferred embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

What is claimed is:

1. A system for video monitoring at least one banking business process comprising:
a video analytics engine to process video of a bank area obtained by a video camera and to generate video primitives regarding the video;
a user interface to define at least one activity of interest regarding the bank area being viewed, wherein each activity of interest identifies a rule and/or a query regarding the bank area being viewed; and
an activity inference engine to process the video primitives according to a banking business process, based on each activity of interest from the user interface to determine if any activity of interest occurred in the video.

2. The system of claim 1, wherein the video analytics engine and the activity inference engine are resident within at least one of: the same device or separate devices, or wherein at least one of the video analytics engine and the activity inference engine is resident in the video camera.

3. The system of claim 1, wherein the video analytics engine operates in at least one of a real-time mode, or an off-line mode.

4. The system of claim 1, wherein the video primitives comprise at least one of a time video primitive, a blob video primitive, a target video primitive, an environmental video primitive, a flow-control video primitives, and/or a special purpose video primitive for a banking business process, the special purpose video primitive including at least one of: a basket run video primitive, a high-value item stealing video primitive, a reaching primitive, a tide filter video primitive, an omni-directional video primitive, and/or a motion histogram video primitive.

5. The system of claim 1, wherein each activity of interest comprises at least one rule element and at least one combinator.

6. The system of claim 1, further comprising:
an alert interface engine coupled to the activity inference engine to generate an alert; and
a report generation engine coupled to the alert interface engine to generate a report based on one or more alerts received from the alert interface engine.

7. The system of claim 1, wherein the at least one banking business process comprises at least one of: physical security, public safety, loss prevention, and/or business intelligence data gathering.

8. The system of claim 7, wherein the physical security banking business process comprises detection of at least one of: intrusion, vandalism, unauthorized access to a secure bank area, illegal number of people in a secure area, suspicious behavior around cars in a parking lot, suspicious behavior around an automated teller machine (ATM), a change in the appearance of an ATM, camera tampering, a customer reaching over the teller station and grabbing money; a person holding a gun, and/or employees violating internal processes.

9. The system of claim 7, wherein the public safety banking business process comprises detection of at least one of: people slipping and/or falling on bank property, people or vehicles moving at excessive speed on bank property, an assault, an abduction, an obstruction of a safety exit, an illegally parked vehicle, high density crowding, an abandoned package, and/or a vehicle proceeding in the wrong direction in a drive-through teller window.

10. The system of claim 7, wherein the intelligence data monitoring banking business process comprises at least one of: tracking people through the bank area to determine a number of people entering and/or exiting the bank area, tracking people in the bank area to determine where the people stay in the bank area, monitoring a queue length, monitoring bank cleanliness, monitoring an unattended delivery, and/or monitoring banking employee-customer interactions.

11. The system of claim 1, further comprising:
an external primitive generator to convert external information into external primitives;
wherein the user interface defines at least one activity of interest regarding the bank area being viewed and the external information;
wherein each activity of interest identifies a rule and/or a query regarding the bank area being viewed and its relationship to the external information; and
wherein the activity inference engine additionally processes the external primitives, according to the banking business process, based on each activity of interest to determine if any activity of interest occurred in the video in combination with the external information.

12. The system of claim 11, wherein the at least one banking business process comprises at least one of: physical security, public safety, loss prevention, and/or business intelligence data gathering.

13. The system of claim 12, wherein the physical security banking business process comprises detection of at least one of: suspicious behavior around an ATM, and/or a suspicious transaction by a bank teller.

14. The system of claim 1, wherein each activity of interest defines a rule and/or a query selectively identified by a user regarding the bank area being viewed.

15. The system of claim 1, further comprising:
an alert interface to create alerts; and
a data combination and inference engine adapted to combine external data from an external data source with an alert from the alert interface to infer combined events based on a set of rules and queries, wherein the combining is done in parallel with the video processing, and to generate at least one of: a combination alert, or a report.

16. A method for video monitoring at least one banking business process comprising:
obtaining video of a bank area from a video camera;
processing the video obtained from the video camera and generating video primitives regarding the video;
defining at least one activity of interest regarding the bank area being viewed, wherein each activity of interest identifies a rule and/or a query regarding the bank area being viewed; and
processing the video primitives according to a banking business process, based on at least one activity of interest regarding the bank area being viewed to determine if any activity of interest occurred in the video, wherein the at least one activity of interest defines a rule and/or a query selectively identified by a user regarding the bank area being viewed;
creating an alert when an activity of interest occurs;
combining external data from an external data source with the alert and inferring combined events based on a set of rules and queries, wherein the combining is done in parallel with the video processing; and
generating at least one of: a combination alert, and/or a report.

17. The method of claim 16, further comprising:
converting external information into external primitives;
wherein defining at least one activity of interest includes defining at least one activity of interest regarding the bank area being viewed and the external information, wherein each activity of interest identifies a rule and/or a query regarding the bank area being viewed and its relationship to the external information; and
wherein processing the video primitives includes processing the video primitives and the external primitives, according to a banking business process, based on each activity of interest to determine if any activity of interest occurred in the video in combination with the external information.

18. A computer-readable medium comprising software for video monitoring at least one banking business process, which when executed by a computer system, cause the computer system to perform operations comprising a method of:
processing video of a bank area obtained by a video camera and generating video primitives regarding the video;
defining at least one activity of interest regarding the bank area being viewed, wherein each activity of interest identifies a rule and/or a query regarding the bank area being viewed;
processing the video primitives according to a banking business process, based on at least one activity of interest regarding the bank area being viewed to determine if any activity of interest occurred in the video, wherein the at least one activity of interest defines a rule and/or a query selectively identified by a user regarding the bank area being viewed;
creating an alert when an activity of interest occurs;
combining external data from an external data source with the alert and inferring combined events based on a set of rules and queries, wherein the combining is done in parallel with the video processing; and
generating at least one of: a combination alert, and/or a report.

19. The computer-readable medium of claim 18, the operations further comprising:
converting external information into external primitives;
wherein defining at least one activity of interest includes defining at least one activity of interest regarding the bank area being viewed and the external information, wherein each activity of interest identifies a rule and/or a query regarding the bank area being viewed and its relationship to the external information; and
wherein processing the video primitives includes processing the video primitives and the external primitives, according to a banking business process, based on each activity of interest to determine if any activity of interest occurred in the video in combination with the external information.

20. An apparatus for video monitoring at least one banking business process comprising:
a video analytics engine to process video of a bank area obtained by a video camera and to generate video primitives regarding the video;
an activity inference engine to process the video primitives from the video analytics engine according to a banking business process, based on at least one activity of interest regarding the bank area being viewed to determine if any activity of interest occurred in the video, wherein each activity of interest defines a rule and/or a query selectively identified by a user regarding the bank area being viewed; and
a data combination and inference engine adapted to combine external data from an external data source with an alert to infer combined events based on a set of rules and queries, wherein the combining is done in parallel with the video processing, and to generate at least one of: combination alerts, and/or reports.

21. The apparatus of claim 20, wherein the video analytics engine is resident within a chip, a chip set, or chips.

22. The apparatus of claim 20, wherein the video analytics engine and the activity inference engine are both resident within a chip, a chip set, or chips.

23. The apparatus of claim 20, further comprising:
an external primitive engine to convert external information into external primitives; and
wherein the activity inference engine processes the video primitives and the external primitives, according to a banking business process, based on each activity of interest regarding the bank area being viewed and the external information, wherein each activity of interest identifies a rule and/or a query regarding the bank area being viewed and its relationship to the external information, to determine if any activity of interest occurred in the video in combination with the external information.
